(19) United States
(12) Patent Application Publication
(10) Pub. No.: US 2014/0006101 A1
(43) Pub. Date: Jan. 2, 2014

(54) SYSTEM FOR THE REGISTRATION, COMPENSATION, MANAGEMENT AND ANALYSIS OF PRODUCT OR CONTENT CUSTOMIZED PURCHASE OR SELLING

(71) Applicant: Antonio ANDRADE, Sao Juliao do Tojal (PT)

(72) Inventor: Antonio ANDRADE, Sao Juliao do Tojal (PT)

(21) Appl. No.: 13/921,255

(22) Filed: Jun. 19, 2013

Related U.S. Application Data
(63) Continuation-in-part of application No. 13/258,456, filed on Sep. 22, 2011, now abandoned.

(30) Foreign Application Priority Data
Mar. 24, 2009 (PT) 10410

(51) Int. Cl. G06Q 30/02

(52) U.S. Cl. CPC G06Q 30/0201
USPC 705/7.29

(57) ABSTRACT

The present invention refers to the customization of generic product and/or content purchase and/or offering, either comprising or not a social responsibility parameter by means of a system comprising the incorporation of a key, designated token, which solely identifies each item of said products. By means of an adequate incentive such as rendering a specific offer, the purchaser and/or recipient of the offer, will use this key to personally identify himself before the system, namely by means of a proper site on the Internet, through telephone line, SMS, MMS, WAP, among others. The present invention describes a system, database and co-related methods allowing the said functionality. By means of this identification it is possible to convert generic product and/or content purchase and/or offering, either with or without a social responsibility parameter, into totally identified transactions, thus generating information and allowing its validation and promotion.

### RELATED APPLICATIONS

This application claims priority under 35 U.S.C. 120 as a continuation in part of application Ser. No. 13/258,456 filed on Sep. 22, 2011 the disclosure of which is incorporated herein by reference.

### TECHNICAL DOMAIN OF THE INVENTION

The present invention refers to a system for registration, compensation, management and analysis of generic product or content customized purchase or selling, with or without a social responsibility parameter, through a unique identification of each item by means of a code and by means of managing the information obtained from said code.

1. Background of the Invention

Companies are facing an extremely competitive, mature, saturated market.

Consumers are changing their purchasing behavior and becoming more and more rational and less emotional, consulting and checking all the offers and prices in the market using all the channels available, namely, internet, telephone contact, personal contact in different distributor and point of sales.

Consumers are beginning to be more and more social and before making the final decision they check references and experiences with their social and professional network.

Consumers have more and more difficulties in choosing the best option for their purchasing decision due to the fact that there are several different type of promotions in different sales channels with different prices and different offers, either from the same channel (upselling) or from different channels (cross selling).

Consumers are becoming day-by-day, more demanding, informed, autonomous, and rational and analytics, valuing their time; space and timings (decision process) being less and less open to general non-targeted, non-personal approach

In this context it is very important to contact actual and potential clients through the right channels, in the correct time with the accurate message and promotion or bundling, respecting client's privacy, individuality and space.

It is of extreme importance to establish a bidirectional relationship with actual and potential clients, to know their demographic, psychographic, relationship and purchasing profile in order to enable companies to deliver the right product, offer, promotion (bundling, upselling and cross selling) suitable to their needs, in the correct channel and time with the accurate message in a non intrusive way assuring at the same time a exclusivity feeling without putting in cause the distribution channel policies.

2. State of the art

US Application US 2002/0188509 A1 discloses a system for implementing a loyalty program on a network-wide level. The system associates UPC and SKU data on a network level to reward consumers and/or to analyze the data for a variety of business purposes, such as market segmentation analyses and/or analyses relating to consumer spending behaviors or patterns, for example.

However, the system disclosed in US 2002/0188509 A1 does not allow the tracking of purchases by actual or potential consumers throughout the value chain of the company without the need of collaboration of third parties, namely retailers or distributors.

The system disclosed in US 2002/0188509 A1 does not enable companies to establish a qualified, personalized, relevant bidirectional relationship with actual and potential clients, with pre-established rules and targeted advertising and promotional offers according to consumer real profile (CRP), consumer social profile (CSP) and consumer life time value (CLTV).

The system disclosed in US 2002/0188509 A1 does not enable companies to know in real time the return of investment in each marketing action, to measure the productivity of each department, division, business, distribution channels, partners and employees.

The system disclosed in US 2002/0188509 A1 does not allow companies to reward consumers with offline and online transactions in any part of the world without any middleware, software and internet connection.

The system disclosed in US 2002/0188509 A1 does not enable consumers to make donations directed to the charity institution and activity of their choice and to track those donations.

### ADVANTAGES OF THE INVENTION

The invention allows companies to reward client's affiliations according with offline and online transactions, during a certain period of time or in certain number of interactions in any part of the world without any middleware software and Internet connection. Whether the affiliation is started in an online or offline session, the link and the connection is always traced by the owner of the affiliation program and by the affiliate receptor.

The invention allows companies to collect and emit personalized information, awarding prizes, rewards and remuneration to their network distribution and their collaborators, based on their productivity.

The invention provided Loyalty Program, Promotions, Deals and Instant Affiliation to existing customers, a company or a group of companies in partnership in few minutes time, in their browser, without the need for dedicated hardware or software.

The invention the provides the building of gradual, non-intrusive bilateral relationship, with full respect for customers privacy data, that is progressively provided by the customer conquered by the company, while offering the right value for their preference through interactive offers, with the right message, advertising, promotional offers, correct channels and timing, in order to win (acquisition cost), Retain Customers (Cost loyalty) and Reduce Churn.

The invention enables brands and companies to analyze the consumer buying behavior, preferred offers, purchase interests, etc. with their consent. The win-win relationship promotes their adhesion to marketing permission.

The fact that each one of the interactive offers has a unit cost, a bi-directional relationship (online and offline) with customers and the fact that resources allocated to the redemption offer are traceable, allows companies to redefine the Pricing Product Model, Promotion Tactics and Sales' Points, differentiating them from competitors, allows companies to measure their performance in real time and to establish a different interactive connection with consumers (actual and potential consumers).

The collection of traceable online and offline information allows a disruption on several industries, including advertising, printing, publishing, media, logistics, distribution, etc

### GENERAL DESCRIPTION OF THE INVENTION

The present invention overcomes all the above mentioned problems of the state of the art, by proving a method for the registration, compensation, management and analysis of items or content customized purchase items, gifts or selling items comprising:
a) a central database managed by one or more servers;
b) means adapted to generate and incorporate in a certain item of the company of an individual, unique and unrepeatable serial sequential code identifying solely such item in the central database;
c) means adapted to make a pre-qualification of said code according to the destination of the item, the information to be collected (demographic, psychograph and relational profile and consumer life time value) and the information to be issued (interactive offer, publicity or promotional offer);
d) means adapted to make an interconnection between the physical flow of the item and the virtual flow of the information collected and issued according the actual destination of each item at a given time;
e) means for the collection of said code, after the consumer has inserted the respective item;
f) means for the registration of personal data of the consumer in the central database, including permission marketing;
g) means adapted to manage, interconnect, qualify and make the tracking of the information collected during all individual item transactions, gifts and interactions throughout the value chain of the company without the need of collaboration of third parties, namely retailers or distributors;
h) means adapted to make the conversion of individual transactions into a customized purchase pattern.

The method of the invention is adapted to motivate the insertion of the code or numbering by means of awarding the consumer with an interactive offer, adapted according to pre-established rules of the company.

The interactive offer is unique, exclusive, one time used and limited to the codes issued by the company according to pre-established rules, each code having a unit value and being offered to company's actual consumers and potential customers in their different touch points (communication in several media platforms and distribution channels) after consumer having validated such code, giving the required data and allowing permission marketing.

The method of the invention allows the tracking of the information collected during all the individual item transactions, gifts and interactions throughout the value chain of the company, by means of a specific platform.

The Method of the invention allows the intervening departments in the value chain of the company to change the pre-qualification of the code and the interactive offer at any time prior to the redemption of the offer by the consumer of after such redemption according to the company's needs at any given moment.

In a further embodiment, the method of the invention allows the consumer with the possibility to assign monetary and/or service contributions to charities of its choice, with origin in their own pocket and or within the partnership established in the technological platform between brands and consumers.

Each donation can be tracked, with a relation cause effect, controlled in the technological platform, begin in the online or offline world, virtualized, multiplied and materialized without requiring middleware, software and hardware or real time connection internet.

With the present invention, fund raising activities can have origin in every corner and point of sale in the world has it does not needs the collaboration of the distribution channels or Internet.

The donor may retain the information from private contribution or he can share it in social networks (Facebook, Google plus, twitter, etc. . . . ) automatically improving his virtual image.

### DESCRIPTION OF THE DRAWINGS

For an improved understanding of the invention, drawings are enclosed hereto, which illustrate preferential embodiments of the invention not aiming however to limit the scope of the present invention.

FIGS. 1 and 2: Schematic representation (non-inclusive or mandatory) of the cycle for product and/or content purchase and/or offering, with or without a social responsibility parameter, offer rendering, identification and registration before the system, customized additional-value proposal.

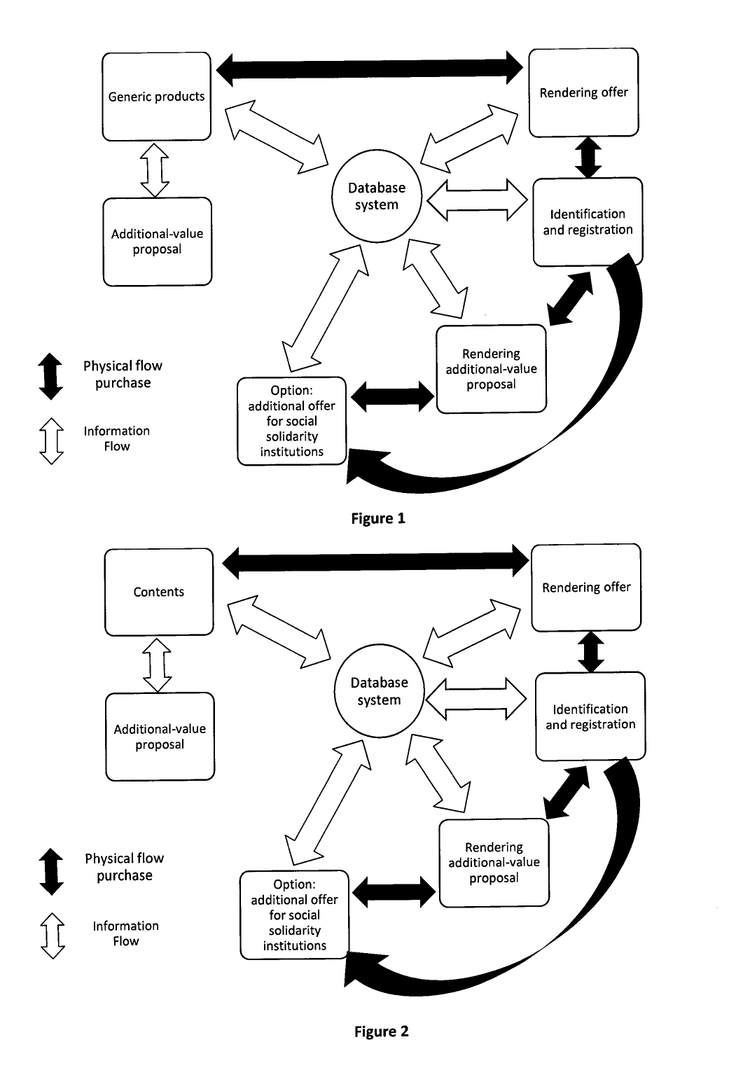

FIGS. 3 and 4: Schematic representation (non-inclusive or mandatory) of the information centrally registered and processed by the system of the present invention.

FIGS. 5 and 6: Schematic representation (non-inclusive or mandatory) of the associated partners and respective information exchange based on the system of the present invention.

### DETAILED DESCRIPTION OF THE INVENTION

Option 1 (Interactive Offer at Logistics):

Step 1: Code Generation

1.1.

Generation of a unique and unrepeatable sequential serial code and of the corresponding barcode to identify each item of the company.

Item means, but not limited to, any:
Product(s), Service(s), Content(s) at logistics;
Offers (Promotional Material, Graphic Material, Advertising, Etc. . . . ) at logistics;
Interaction at the point of sale, either in case of Sales: Products, Services and or Contents, or personal interactions and/or physical (with no personal interaction) through the Offer of promotional materials (Offers, Discounts, Loyalty programs, graphic materials, Advertising or of any other type)
Personal Interaction (in other components of the value chain: sales meeting, installation service, after-sales service, etc. . . . ).

1.2.

Generation of a unique and unrepeatable numeric code, random or otherwise (QPR, RFID, etc. . . . ) interconnected with the sequential code to identify each interactive offer of the company.

Step 2: Interactive Offer

2.1.

Production of serial cards (interactive offer) of the company with the sequential code and the corresponding barcode and/or of any other type, visible, and of the unique variable interactive offer code covered, or not, by a scratch-off material and concealment means, or protected inside a tamper-evident package.

2.2.

Printing the sequential code and the corresponding visible barcode (or of any other type), and/or the interactive offer code covered, or not, by a scratch-off material and other concealment means, on the company's items.

2.3.

Printing the sequential code and the corresponding visible barcode (or of any other type), and/or the interactive offer code covered, or not, by a scratch-off material and other concealment means, on promotional gifts, graphic arts, advertisements, etc. . . .

2.4.

Interactive offers are exclusive, but limited to the number of codes that are issued.

2.5

The interactive offer includes, but is not limited to, prize, compensation or association, in particular experiences, offers, prices and individual discounts, and may be adapted according to pre-established rules.

Step 3: Pre-Qualification of the Codes

Through a technological platform for the Management, Issuance and Analysis of Interactive Offers, managed by one or more servers, the interactive offers are pre-qualified according to the target (location, the typology of the consumer and/or the distribution channel), the typology of the external partner, the type of promotional action, the media and according to the demographic, psychographic and relational profile of the consumer and to the Consumer Life Time Value (CLTV).

Step 4: Adapting the Pre-Qualification of the Interactive Offer to the Company's Needs

Throughout the value chain of the company, the intervening company departments may at any time (prior to the redemption of the offer by the consumer of after such redemption) confirm or make changes to the pre-qualification of the code and interactive offer according to the company's needs at any given moment.

Step 5: Interconnection Between the Physical Flow of the Item and the Virtual Flow of the Information

Through a technological platform for the management, rationalization and control of Logistics, Warehousing and Transportation, managed by one or more servers, an interconnection is made between the physical flow of a company's item and the virtual flow of the sent/received information, according to the actual destination of each item at a given time or moment.

In every physical flow of a company's item a double range of codes is physically and virtually attached: the sequential code and the corresponding code of the interactive offer.

For every physical flow of the item (picking, packaging and dispatching carried out at the warehouse) a certain range of sequential codes and interactive offers is physically allocated, through barcode reading of pistol grip scanners and/or other systems or procedures.

When the current and prospective consumers redeem their interactive offers, the platform for the management, rationalization and control of logistics, warehousing and transportation, through an interconnection with the platform for the management, issuance and analysis of interactive offers will gather the retrieved data according to the target and the type of item, with the type of consumer and the interactive offer codes.

Step 6: Redeeming the Interactive Offer

The redemption of the interactive offer is carried out virtually by technological means (Web, Wap, SMS, smartphone, Bluetooth, Wi-Fi, RF, RF-ID, etc. . . . ), by registration, wherein the consumer inserts the interactive offer code, personal data, allows marketing promotion and redeems the offer.

The redemption of the interactive offer can also be made physically at the point of sale by presenting the card with the interactive offer, as long as the code is validated and activated (registration through technological means).

Step 7: Managing the Received Information and Traceability

Information received through the redemption of the interactive offers is managed according to the pre-qualification and it is cross-checked with the interconnections made with the aforementioned technological platforms, so as to allow the company to track the information received in every individual transaction of the items in the value chain of the company, with no need to resort to third parties, namely stockists and distributors.

Step 8: Specific Back-Office Technological Platform

Throughout the value chain of the company, the intervening company departments (logistics, marketing, sales, after-sales, etc. . . . ) and/or external ones (partners, distribution channels, etc. . . . ), may have access to all the information managed through a specific back-office technological platform, managed by one or more servers, suitable to manage and process real-time information obtained at a certain interaction, according to pre-established rules.

Step 9: Real-Time Management of Received Information

The analysis of real-time generated data on the said specific technological platform, allows the company to collect and process more adequate information on the profile and CLTV of the current and/or prospective consumers, on the results obtained in view of the investments made, on the more effective promotional means and campaigns, etc. . . .

This allows companies and brands to integrate themselves within the society (locally, regional and countrywide) in which they are inserted leveraging the engagement, relevance, connection, loyalty and sales with their actual and potential customers

Option 2 (Interactive Offer at the Point of Sale/other Interactions in the Value Chain):

Step 1: Code Generation

1.1.

Generation of a unique and unrepeatable sequential serial code and of the corresponding barcode (or any other) to identify each item of the company.

Item means, but not limited to, any:
Interaction at the point of sale, either in case of Sales: Products, Services and or Contents, or personal interactions and/or physical (with no personal interaction) through the Offer of promotional materials (Offers, Discounts, Loyalty programs, graphic materials, Advertising or of any other type)
Personal Interaction (in other components of the value chain: sales meeting, installation service, after-sales service, etc. . . . ).

1.2.

Generation of a unique and unrepeatable numeric code (or any other), random or otherwise (QPR, RFID, etc. . . . ) to identify each interactive offer of the company and interconnected with the sequential identification code.

Step 2: Interactive Offer

2.1.

Production of serial cards (interactive offer), vouchers, tickets printed on the machine at the point of sale of the company, or any other type of printing, with the sequential code and the corresponding barcode (or any other) visible and the variable, unique, exclusive code interconnected with the sequential code covered, or not, by a scratch-off material and another concealment means.

2.2.

Printing the sequential code and the corresponding visible barcode (or of any other type), and/or the interactive offer code covered, or not, by a scratch-off material and other concealment means, on the company's items.

2.3.

Interactive offers are exclusive, but limited to the number of codes that are issued.

2.4

The interactive offer includes, but is not limited to, prize, compensation or association, in particular experiences, offers, prices and individual discounts, and may be adapted according to pre-established rules.

Step 3: Pre-Qualification of the Interactive Offer

Through a technological platform for the Management, Issuance and Analysis of Interactive Offers, managed by one or more servers, the interactive offers are pre-qualified according to the target (location, the typology of the consumer and/or the distribution channel), the typology of the external partner, the type of promotional action, the media and according to the demographic, psychographic and relational profile of the consumer and to the Consumer Life Time Value (CLTV).

Step 4: Adapting the Pre-Qualification of the Interactive Offer to the Company's Needs

Throughout the value chain of the company, including during the interaction at the point of sale or the personal interactions, the intervening company departments may at any time (prior to the redemption of the offer by the consumer of after such redemption) confirm or make changes to the pre-qualification of the code and interactive offer according to the company's needs at any given moment.

Step 5: Interconnection Between the Physical Flow of the Item and the Virtual Flow of the Information

Through a technological billing an interaction platform, managed by one or more servers, an interconnection is made between a certain interaction (sales meeting) and/or the sale of a item and the virtual flow of the sent/received information, according to the location of the sales, the typology of the product purchase and/or the interpretation of the company's representative (sales person) about the pre-qualification of the demographic, psychographic and relational profile of the consumer and the Consumer Life Time Value (CLTV).

In every physical flow (sales at the store or at any point of sale) and/or interaction (sales meeting) of a company's item a double range of codes is physically and virtually attached: the sequential code and the corresponding code of the interactive offer.

For every physical flow of the item (sales at a store or at any point of sale) and/or interaction (sales meeting) a certain range of sequential codes and interactive offers is physically attached, through barcode reading of pistol grip scanners and/or other systems or procedures.

When the current and prospective consumers redeem their interactive offers, the billing and interaction platform, through an interconnection with the platform for the management, issuance and analysis of interactive offers will gather the retrieved data according to the type of interaction and/or sale, with the time and place of such interaction and/or sale, with the type of consumer and the interactive offer codes.

Step 6: Redeeming the Interactive Offer

The redemption of the interactive offer is carried out virtually by technological means (Web, Wap, SMS, smartphone, Bluetooth, Wi-Fi, RF, RF-ID, etc. . . . ), by registration, wherein the consumer inserts the interactive offer code, personal data, allows marketing promotion and redeems the offer.

The redemption of the interactive offer can also be made physically at the point of sale by presenting the card with the interactive offer, as long as the code is validated and activated (registration through technological means).

Step 7: Managing the Received Information and Traceability

Information received through the redemption of the interactive offers is managed according to the pre-qualification and it is cross-checked with the interconnections made with the aforementioned technological platforms, so as to allow the company to track the information received in every individual transaction of the items in the value chain of the company, without the need to resort to third parties, namely stockists and distributors.

Step 8: Specific Back-Office Technological Platform

Throughout the value chain of the company, the intervening company departments (logistics, marketing, sales, after-sales, etc. . . . ) and/or external ones (partners, distribution channels, etc. . . . ), may have access to all the information managed through a specific back-office technological platform, managed by one or more servers, suitable to manage and process real-time information obtained at a certain interaction, according to pre-established rules.

Step 9: Real-Time Management of Received Information

The analysis of real-time generated data on the said specific technological platform, allows the company to collect and process more adequate information on the profile and CLTV of the current and/or prospective consumers, on the results obtained in view of the investments made, on the more effective promotional means and campaigns, etc. . . . without requiring hardware at the point of sale.

This allows companies and brands to integrate themselves within the society (locally, regional and countrywide) in which they are inserted leveraging the engagement, relevance, connection, loyalty and sales with their actual and potential customers.

Assignment of Monetary and/or Service Contributions to Charities:

In a further embodiment, the method of the invention allows the consumer with the possibility to assign monetary and/or service contributions to charities of its choice.

Alternatively to the redemption of the interactive offer, by means of code and numbering insertion and registration in the technologic platform, the consumer has the possibility to assign monetary and/or service contributions to charities of its choice, the value of the contribution being set by the consumer among several values and selections which are defined by the entity offering said values.

The assigned monetary or service contribution can be virtualized and/or physically transformed in controlling codes according with the internet access availability in the donation's destiny country and assigned to different entities with oppose interests (donations receiver, donations local entity, donations ambassador, donations activity supplier, etc.), who will control each other and assure the donor that the monetary funds will only be transferred when the money reach the donations receiver and or the activity is done and when all the controlling codes are inserted in the platform.

### Additional Details

The present invention includes providing conventional physical products with a key, designated token, which identifies solely each item. That is, from said token it is possible to identify, not only the category and product, but also the item in question.

This way, each code is mandatorily unique consequently identifying a purchaser and/or offer recipient, a transaction, a salesperson and an item of a specific product.

Specification: Contents (CD, DVD'S, Games, UMD, etc.)

This possibility is highly interesting for products carrying contents because, besides the frequent contents in standard and normal physical supports (CD, DVD, GAMES, Blue-Ray, UMD, among others) and normally used to market such contents in delivering channels, there is the possibility to add VALUE and/or information to these content delivering supports with the additional and integrated offer of Additional Experiences (Example: concert ticket, Preferential sites, etc.) and customer loyalty development instruments (Example: offers, discounts, coupons--additional vouchers, and access to restricted-member club), only accessible to those purchasing such content delivery support, by means of the said token.

As previously described, each content delivering support requires a different code and/or unique numbering allowing the final consumer to have access to said offers. The access to the these additional offers can be pursued in a technological platform (Web, Wap, etc.), directly at a sales outlet, but always by presenting a physical or digital evidence (the said token).

The final Consumer can also have access to unique experiences (e.g., preferential seats in a concert, access to after party--post-concert private party) by presenting this physical and/or digital evidence.

This physical and/or digital evidence can also be the evidence of club membership and can be an interface between the manufacturer and the final consumer.

It is further possible for the final consumer to decide on offering the value of his offers, contact value in the database, value regarding additional purchases and/or providing indication of other potential purchasers to social solidarity institutions exempt from any increment costs.

An example of a generic product and/or content offer, with or without social responsibility parameter, would be a watch, a T-shirt or a CD offered by a telecommunication company, thus allowing the offer recipient, upon token rendering and registration on the database, to obtain additional experiences (Ex.: Access tickets for concerts sponsored by the company, VIP seats, etc.), club membership and/or exclusive offers and discounts, explanatory video on product ‘use, exclusive offers and discounts in Products and Offers of the said company and/or partners thereof, etc.

The ordering and numbering of each support and/or offer can be carried out by individually customizing a pamphlet, distich, label and/or card. The number or code of the token can also be printed in the product itself (for instance, book cover) or inclusively be obtained by electronic means (SMS, web, etc. . . . ), but it will always be unique and unrepeatable.

The recipient of this business offer (generic product and/or content) might also decide on offering the value of his additional offers, contact value in the database, value regarding additional purchases and/or providing indication of other potential purchasers to social solidarity institutions.

This way, when the final consumer purchases and/or receives and renders these customized generic product and/or content offers, he is not only buying products and/or contents in a physical support, but is also buying and benefiting from the possibility to access additional experiences, to improve his consumption experiences, to become a member of a community and loyalty program, to have access to a series of offers and relevant discounts and to contribute for society through relevant acts and/or actions in a mutually beneficial relationship with the entity to whom the product/service was purchased.

Token Mechanism
1. Token, for instance through unique card, ordered, numbered and interconnected, in either physical or digital format.
2. Printing of a unique, ordered, numbered and interconnected number, in either physical or digital format, onto the physical support itself, onto the content, product and/or service.

Limited Access Accessible by the Token

The final consumer has access to these advantages, through:
1. Technological platforms: Web, Wap, SMS, telephone, Bluetooth, Wi-Fi, RF, RF-ID and/or other means that might come to be created.
2. Sales Outlet by presenting the physical support wherein the unique number is written or engraved.
3. Specific sites and/or events wherein these advantages are available for rendering.

Benefits for the Final Consumer/Offer Recipient
1. Access to additional exclusive Experiences and Services—sales outlet, on-line
2. Explanatory Video of Product use
3. Personalized advisory
4. Subscription in Loyalty Programs
5. Special offers
6. Special discounts
7. Possibility to offer and contribute to social solidarity institutions, exempt from increment costs.

Specification: BOOK/Magazine Contents (selling to final consumer and/or offer, with or without social responsibility parameter)

For instance, in the case of purchasing a book or magazine, the final consumer has access to:

‘Loyalty Program’ Membership

Detailed information on constant contents in the book or magazine.

Therefore, the final consumer has the possibility to thoroughly deepen the contents of his outmost interest (on-line, telephone, etc.):

Videos, interviews

Access to Merchandising

Exhibitions, Congresses, Interviews, etc.

The company owning the contents has the possibility to generate additional incomes since the Token might have a limited duration (Time and or no. of access situations and accessible information, without incurring any increment costs).

Information Management and Analysis

By interconnecting the code with a specific product, for instance a specific CD, it is possible to access information on multiple CDs, products, downloads, etc.

This way, it is possible to perform a purchase profile, as well as a profile for additional uses/renderings/experiences inherent to a user, even if among different products, from different manufacturers, and among non-related sales outlets.

Naturally, the individual anonymity of the user can be guaranteed, depending on the option of the user or on the conditions underlying the accomplished offers.

Database management can be performed by a third party which guarantees contact and profile anonymity and which proceeds with selling the database, upon authorization of all parties involved including that of the final consumer.

By means of the solution herein set forth, it is possible to convert an unknown consumer and/or offer recipient into a loyalty-secured buyer/consumer having a strong relationship, given that this connection crosses beyond the boundaries of the individual product, sales outlet and of the manufacturer itself, associating individual purchase performances within a single profile.

It is also possible to undertake up selling and cross selling actions with products from the company and its partners, always with the final consumer's agreement.

The database itself can be marketed with other partners, upon agreement of all parties involved, as described below.

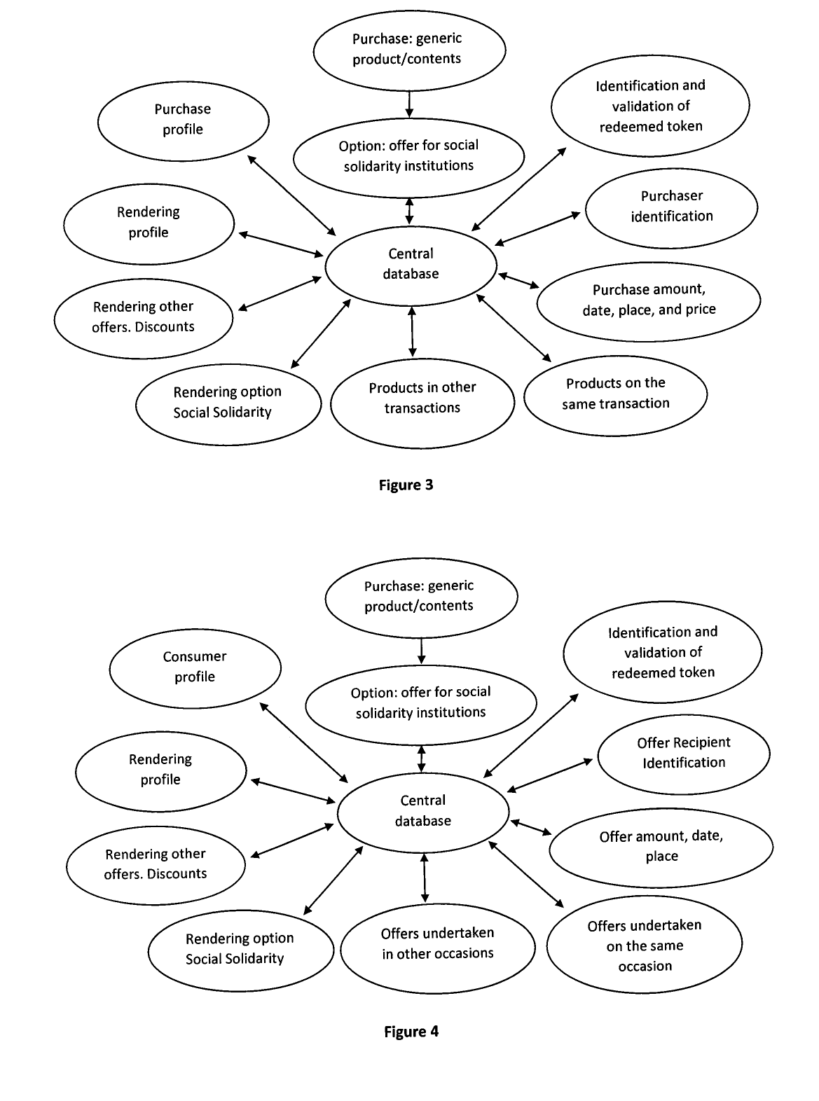

This profile is valuable due to the information made accessible, as described in FIG. 3 or 4.

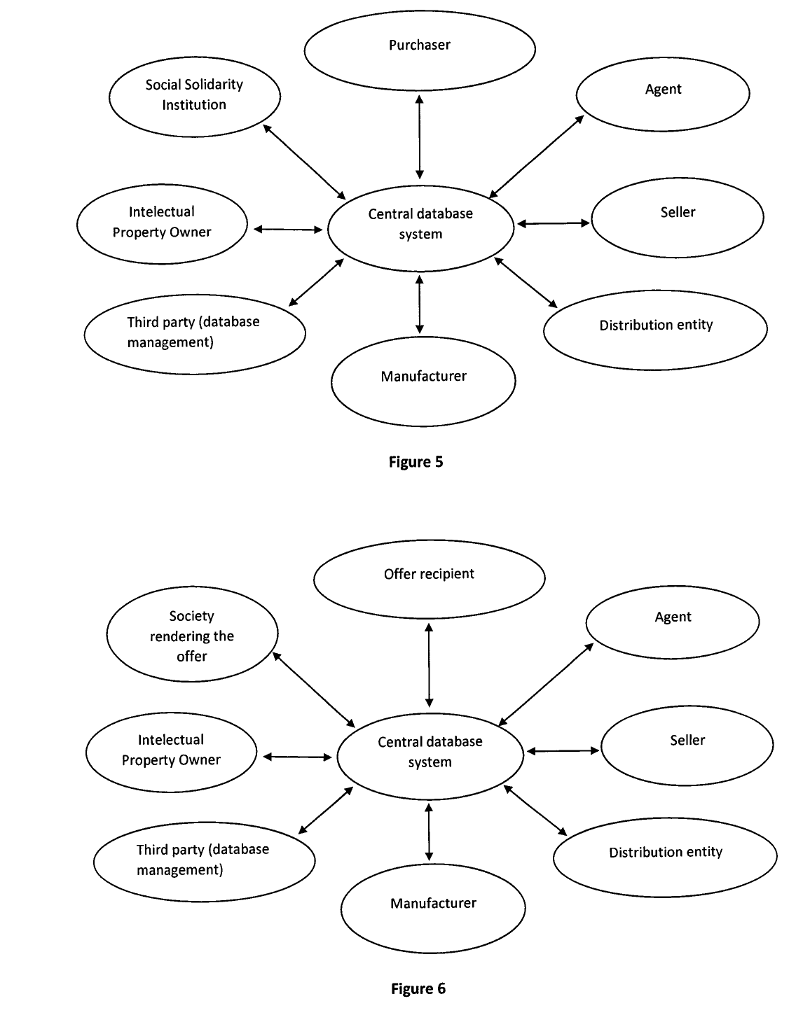

Finally, FIGS. 5 and 6 describe how the information is shared among the different partners of the system.

Depending on the authorization by the consumer and on the agreements between salesperson (sales outlet), agent (sales promoter), distribution entity (connection between manufacturer and salesperson) and the own manufacturer (responsible for the product/service in itself) and Social Solidarity institution, the information is shared among the parties, or not.

Depending on the authorization by the offer recipient and on the agreements between Society rendering the offer, salesperson (sales outlet and Offer Place), agent (sales promoter), distribution entity (connection between manufacturer and salesperson) and the own manufacturer (responsible for the product/service in itself) and Social Solidarity institution, the information is shared among the parties, or not.

So being, for instance, two manufacturers may agree to exchange their particular information, or a distribution entity may sell or rent the information to a manufacturer having interest in a new market. Finally, and still depending on the executed agreements, the entity being responsible for managing the own system may sell and/or rent the information on commissioning, the main value being allocated for the respective owner.

I/We claim:

1. A system for the registration, compensation, management and analysis of product items or content customized purchase items or selling items comprising:
a) a central database managed by one or more servers;
b) means adapted to generate and incorporate in a certain item of an individual, unique and unrepeatable serial sequential code identifying solely such item in the central database;
c) means adapted to make a pre-qualification of said code according to the destination of the item, the information to be collected (demographic, psychograph and relational profile and consumer life time value) and the information to be issued (interactive offer, publicity or promotional offer);
d) means adapted to make an interconnection between the physical flow of the item and the virtual flow of the information collected and issued according the actual destination of each item at a given time;
e) means for the collection of said code, after the consumer has inserted the respective item;
f) means for the registration of personal data of the consumer in the central database, including permission marketing;
g) means adapted to manage, interconnect, qualify and make the tracking of the information collected during all individual item transactions or interactions throughout the value chain of the company without the need of collaboration of third parties, namely retailers or distributors;

2. A system according to claim 1 wherein the individual, unique and unrepeatable serial sequential code comprises a bar code and a random numeric code.

3. A system according to claim 1 wherein the unique serial sequential code is individually incorporated into each item by means of:
a) Inserting a serial card, either in physical or digital format or,
b) Printing onto the physical support of the item a serial number, either in physical or digital format.

4. A system according to claim 1 wherein each physical flow of each item is physically allocated, by reading the bar codes and/or other methods or processes, a certain dual range of sequential codes and interactive offers.

5. A system according to claim 1 wherein interconnection between the physical flow of the item and the virtual flow of the information collected and issued is made by means of a technologic platform managed by one or more servers.

6. A system according to claim 1 adapted to motivate the insertion of the code or numbering by means of awarding the consumer with a prize, compensation or association, in particular experiences, offers, prices and individual discounts, adapted according to pre-established rules, comprising means for converting the said awards into a customized awarding pattern.

7. A system according to claim 1 adapted to allow the insertion of the individual, unique and unrepeatable serial sequential code and rendering of the offer by means of:
a) technological platforms, in particular Web, Wap, SMS, telephone, Bluetooth, Wi-Fi, RF, RF-ID, or
b) presentation at the sales outlet of physical support showing written or engraved said code, or
c) specific places and/or events wherein the said offers will be available for rendering.

8. A system according to claim 1 wherein the tracking of the information collected during individual item transactions or interactions throughout the value chain of the company is made by means of a specific platform managed by one or more servers adapted to collect and process real-time information obtained during a given interaction, according to pre-established rules.

9. A system according to claim 1 wherein the change of the pre-qualification of the code and the interactive offer may be done by the intervening departments in the value chain of the company at any time prior to the redemption of the offer by the consumer of after such redemption according to the company's needs at any given moment.

10. A system according to claim 1 comprising additionally means to provide, by means of code and numbering insertion and registration in the central database, the consumer with the possibility to assign monetary and/or service contributions to charities of its choice, the value of the contribution being set by the consumer among several values and selections which are defined by the entity offering said values.
